(19) United States
(12) Patent Application Publication
(10) Pub. No.: US 2007/0237589 A1
(43) Pub. Date: Oct. 11, 2007

(54) Knife with a Cavity

(76) Inventor: Ralf Peter Mueller, Kempten (DE)

Correspondence Address: PERMAN & GREEN, 425 POST ROAD, FAIRFIELD, CT, 06824, US

(21) Appl. No.: 10/565,112

(22) PCT Filed: Jul. 19, 2004
(86) PCT No.: PCT/EP04/08046

§ 371 Date: Feb. 26, 2007

(30) Foreign Application Priority Data
Jul. 18, 2003 (DE) 103 33 062.3

(51) Int. Cl. B26D 1/29

(52) U.S. Cl. 408/16; 73/46; 76/115

(57) ABSTRACT

The present invention relates to a knife for cutting meat or meat-like products, cheese and the like, the knife being made up of a hub (9) and a cutting body (10). The cutting body has a cavity (4), preferably composed of a first (2) and a second half-shell (3). The invention also relates to a method for producing knives with a cavity as well as to a method for detecting leakage from the knife cavity, wherein a liquid is filled into the cavity.

The present invention relates to a blade for cutting meat or meat-like products, sausage, cheese and the like, which blade consists of a hub and a cutting body. The cutting body comprises at least one cavity, which is preferably formed by a first and a second half-shell. In addition, the present invention relates to a method of producing blades with a cavity and a method of detecting leakage from the cavity of the blade, wherein the cavity contains a fluid.

These days, blades which are used in industrial food processing for cutting foodstuffs into slices exhibit a very large diameter and are operated at the highest possible rotational speeds, to achieve the highest possible cutting performance. While such machines are in operation, therefore, considerable vibrations and forces arise which may, on the one hand, lead to uneven cutting and, on the other hand, represent considerable dynamic stress to the machine and tool components.

The object of the present invention is therefore to provide a blade for processing meat or meat-like products, cheese and the like with which the stress suffered by the machine may be reduced.

The object according to the invention is achieved by a blade for cutting meat or meat-like products, cheese and the like which consists of a hub and a cutting body, wherein the cutting body comprises at least one cavity.

The blade is preferably composed of a plurality of parts, which are connected together frictionally, interlockingly or by material bonding. The cutting body of the blade preferably comprises two half-shells. For the purposes of the invention, a half-shell is a flat material, preferably a plate, which extends substantially radially outwards from the hub. This flat material is preferably thin-walled. The thin-walled material may be bent to produce a three-dimensional structure. The cavity is preferably located between the first half-shell and the second half-shell and may be of any desired size. The half-shells are connected with the hub preferably frictionally, interlockingly and/or by material bonding. Through one or more of the above-stated measures and the resultant construction, the width of the hub and thus the ratio between the width of the hub and the diameter of the blade may be adjusted as desired, without the mass of the blade being substantially modified, such that it is possible, for example, to produce blades which have a comparatively low weight but are capable of withstanding very high static and dynamic loads. The internal diameter of the half-shells is preferably arranged in each case in the axial end area of the hub. The half-shells may also be connected together reversibly.

The cavity of the blade is preferably at least partially filled with a detection fluid, such that leaks from the cavity may be detected. A suitable detection fluid is any fluid known to the person skilled in the art which is capable of making leakage visible. Food dye is particularly suitable.

In a preferred embodiment, the cavity of the blade is at least partially filled with a plastics filling. In this case, a very light and/or foamed plastics material is preferably used.

The blade is preferably equipped with a closable opening, which allows filling of the cavity with both detection fluid and plastics material. Closure of the opening may also be effected reversibly.

In a preferred embodiment, pressure, preferably overpressure, may be applied to the cavity through the opening. By applying overpressure, and where a detection fluid is used, the detection fluid may be forced out of the cavity if leakage occurs in the cavity of the blade.

The ratio of the hub width to the external diameter of the blade is preferably in the range of 1:3-1:100, particularly preferably in the range of 1:4-1:70 and very particularly preferably 1:5-1:13. The ratio influences the rigidity of the blade. This preferred embodiment of the blade has the advantage that the blade is substantially more stable and rigid than blades according to the prior art.

The width of the hub preferably amounts to 10-300 mm, particularly preferably 15-150 mm.

Preferably, the half-shells of the blade are curved, wherein one half-shell of the blade preferably exhibits a smaller curvature than the other half-shell of the blade.

The blade preferably takes the form of a circular blade. Symmetry enables even running of the blade. It is additionally preferred for the blade to be a crescent-shaped or helical blade.

In a preferred embodiment, the cutting body of the blade comprises two half-shells and a cutting edge. The cutting edge is preferably inserted between the half-shells and preferably enters into a frictional and/or interlocking connection with the half-shells. After assembly of the blade, the half-shells and the blade are preferably materially bonded together. This bond is preferably detachable, such that the cutting edge of the blade may be replaced.

The cutting edge of the blade is preferably made from hardened steel or hard metal, while the half-shells are preferably made from stainless steel, light metal, such as for example aluminium, or high-strength plastics. This embodiment of the present invention has the advantage that the materials used may be of optimum suitability and the weight of the blade may at the same time be kept low.

In a preferred embodiment, the two half-shells exhibit the same diameter.

In another preferred embodiment, the diameters of the two half-shells are of different sizes. In a preferred embodiment, the edge area of the larger half-shell may take the form of a cutting edge, wherein this half-shell is then preferably made from hardened steel or hard metal, while the other half-shell is made from stainless steel or aluminium. When the present invention exhibits this construction, the number of components is reduced and one joint less is involved.

The components of the blade are preferably connected together interlockingly, by material bonding and/or frictionally. In principle, all possible common connecting methods are feasible, but riveting and/or soldering and/or very particularly adhesion and/or welding are preferred.

It is important for the joints to be leakproof, such that no food residues penetrate into the cavity.

Ribs, connecting webs and/or light supporting materials are preferably located between the half-shells, in order to optimise the rigidity of the blade.

Bushes are preferably inserted in the blade, these being used to balance the blade. The bushes may serve at the same time as supporting material.

In a preferred embodiment of the present invention, a temperature-control medium is arranged in at least one cavity, with which medium the blade may be at least partially temperature-controlled; i.e. heated or cooled.

The hollow blade according to the invention is able to effect very good slicing of foodstuffs such as for example sausage, ham or cheese. The foodstuffs are preferably in slab form.

In a preferred embodiment of the present invention, the half-shells of the cutting body are differently embodied. These differences may relate to the material, the shape and/or the thickness of the material of the half-shells. The variability of the parts enclosing the cavity makes it possible to modify purposefully the axial position of the blade cutting edge relative to the hub and/or the angle of the blade cutting edge relative to the hub. Modification of the position of the blade cutting edge may be effected by temperature control of the blade and varying expansion of the two half-shells and/or by applying pressure to the blade cavity, wherein the two half-shells undergo different changes to their shape.

The blade according to the invention is significantly more stable than blades according to the prior art and may be optimally embodied for a particular application. It exhibits a lower weight than blades according to the prior art. The blade according to the invention subjects the cutting machine to less stress. The blade is simple and cheap to produce. Leakage from the cavity is reliably detected.

The present invention further provides a slicing machine of any desired type comprising the blade according to the invention.

The present invention further provides a method of producing blades which comprise a cavity in the cutting body, in which the components of the blade are inserted in one another in succession and in which the components of the blade are connected together interlockingly, by material bonding and/or frictionally. This is a very simple, cheap, quick-to-perform method of producing the blade.

The present invention further provides a method of detecting leakage in blades with a cavity in the cutting body. In the method, the cavity of the blade is at least partially filled with a detection fluid, which escapes from the blade if the cavity has a leak. In this way, leakage may be detected from outside.

In the method, the blade is preferably exposed to a reduced pressure, whereby the detection fluid is forced out of the cavity if a leak is present in the cavity.

In the method, the cavity is particularly preferably exposed to overpressure, whereby the detection fluid is forced out of the cavity if a leak is present in the cavity.

Leakage monitoring is preferably also possible when the blade is in operation. In this way, leaks in the blade may be identified immediately.

In a preferred embodiment of the method, the detection fluid is detected with the aid of a monitoring device. Conventional commercial food dye, for example, may be used as the detection fluid. In this case, image data monitoring, e.g. a video monitoring system, may be used as the monitoring device.

In the method, the cutting process is preferably interrupted immediately if the detection fluid is detected on the products.

The occurrence of leaks such as cracks in the blade is detected immediately by the above-described method. The occurrence of contaminated foodstuffs due to food residues in the cavity of the blade is prevented and thus the production of waste is prevented from the outset.

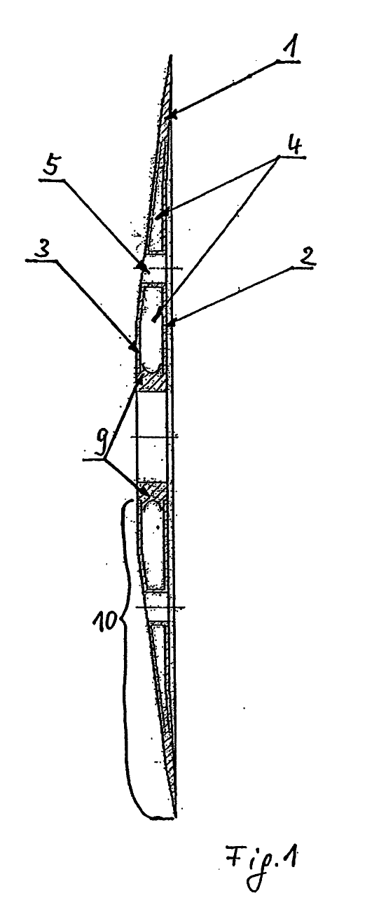

The invention is explained below with reference to FIGS. 1-6. These explanations are given merely by way of example and do not restrict the general concept of the invention.

FIG. 1 shows a cross section through a blade of one possible structural shape.

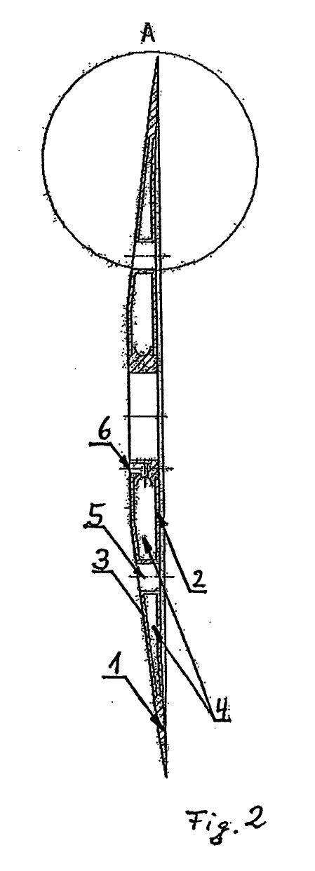

FIG. 2 shows the cross section according to FIG. 1 with bore.

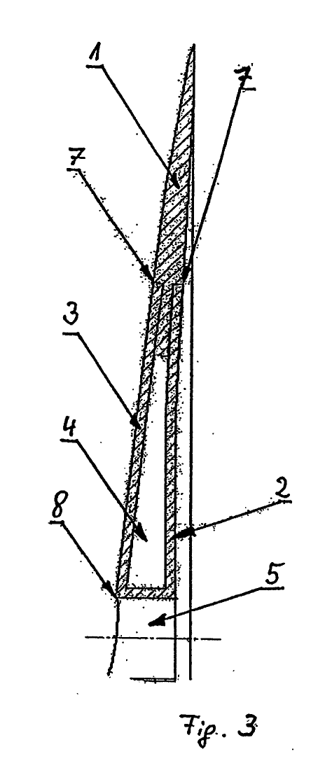

FIG. 3 is an enlarged partial view A of the cross section of the blade according to FIG. 2.

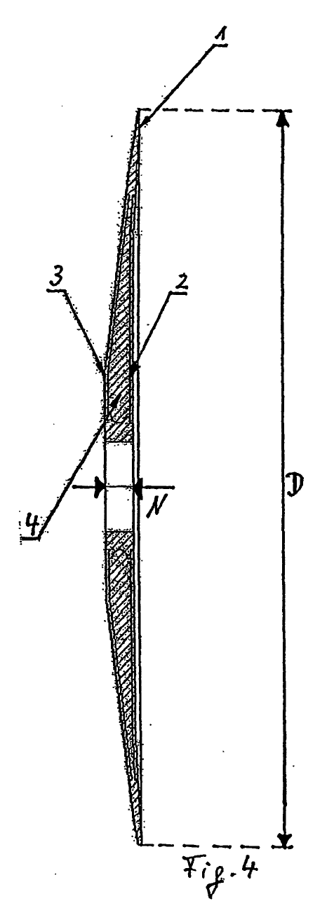

FIG. 4 shows a cross section of another structural shape of the blade with plastics filling.

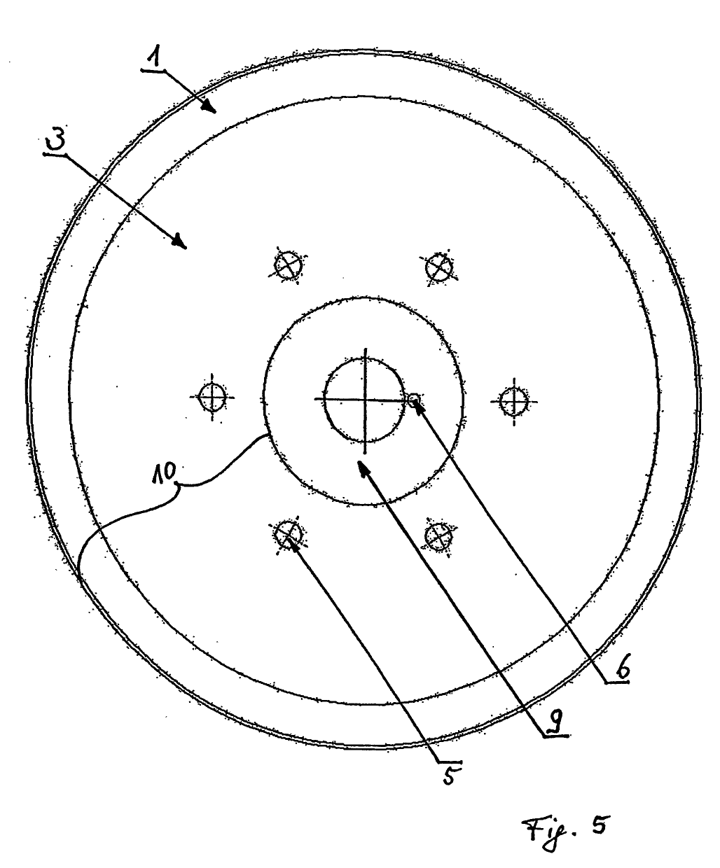

FIG. 5 is a plan view of the blade according to the invention.

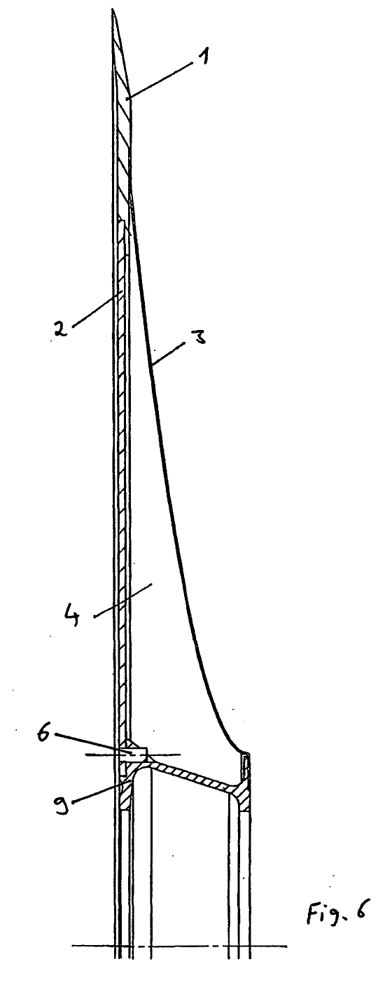

FIG. 6 shows a blade according to the invention in an asymmetric embodiment.

FIG. 1 shows a cross section through one possible structural shape of the blade. The Figure shows the subdivision of the blade into hub 9 and cutting body 10. The blade cutting edge 1 is inserted between two half-shells 2, 3 of equal diameter. The half-shells are curved, wherein the curvature of the first half-shell 2, which is located on the side facing the product to be cut, is smaller than the curvature of the second half-shell. The cavity 4 is visible between the half-shells 2, 3. Bushes 5 are inserted into the blade for balancing and as supporting material.

FIG. 2 essentially shows the cross section according to FIG. 1. However, this Figure additionally shows the opening 6, through which the cavity 4 may be filled and through which pressure, preferably overpressure, may be applied to the cavity 4.

FIG. 3 shows the portion A of FIG. 2 on an enlarged scale. Here the joints 7 between the blade cutting edge 1 and the half-shells 2, 3 are visible, these preferably being adhesively bonded or welded, and the joint 8 between the inserted bush 5 and the half-shells 2, 3, which is preferably welded. The drawing additionally shows in particular the shape of the cutting edge 1. The part of the cutting edge 1 which extends between the half-shells 2, 3 widens towards the inside. In this way, the cutting edge 1 is connected interlockingly and/or frictionally with the half-shells 2, 3. The forces are distributed along the entire contact surface between half-shells 2, 3 and cutting edge 1. The bond between half-shells and cutting edge is such that it is difficult for foodstuffs to penetrate into the cavity 4.

FIG. 4 shows a cross section through a different structural shape of the blade, which differs from the structural shape of the previous Figures in that the cavity 4 is filled with a plastics material, preferably a foamed plastics material. The plastics material prevents the penetration of cut material into the cavity. This Figure additionally clarifies, by way of example for all the Figures, the ratio N:D of the width of the hub N to the external diameter D of the blade.

FIG. 5 is a plan view of the blade according to the invention. It shows the structure of the blade consisting of the hub 9 and the cutting body 10. The parts of the cutting body which are visible are one half-shell 3 and the blade cutting edge 1, which is attached to the half-shell 3. Bushes 5 are inserted into the half-shells, which bushes may be used to balance the blade and as a supporting material. Likewise visible is the opening 6 which may be used to fill the cavity 4 with plastics material or detection fluid and through which pressure, preferably overpressure, may be produced in the cavity 4.

FIG. 6 shows a further embodiment of the blade according to the invention, comprising a cutting edge 1 and two half-shells 2, 3. The half-shell 3 is in the present case of substantially thinner construction than the half-shell 2 and exhibits a curved three-dimensional shape. If overpressure is applied to the connection 6, for example, the curved shape is forced at least partially reversibly out of the half-shell 2 and the cutting edge 1 of the blade is forced leftwards relative to the hub. If a reduced pressure is applied, the three-dimensional shape of the half-shell 2 may be further intensified, which results in a rightwards movement of the cutting edge 1 relative to the hub.

The same effects may be achieved if materials with different coefficients of thermal expansion are used for the two half-shells and the cavity 4 is filled with hot or cold media.

Both embodiments according to FIG. 6, but in particular the former, are suitable, for example, for adjusting the cutting gap.

### LIST OF REFERENCE NUMERALS

1 Cutting edge of blade
2 First half-shell, facing product to be cut
3 Second half-shell
4 Cavity between half-shells
5 Bush for balancing purposes and as supporting material
6 Opening for introduction of foamable plastics material and/or detection fluid and for producing overpressure in the cavity
7 Joint between cutting edge and half-shells, produced for example by adhesive bonding or welding
8 Joint between bush and half-shells, produced for example by adhesive bonding or welding
9 Hub of blade
10 Cutting body of blade
N Hub width of blade
D External diameter of blade

1. A blade for cutting meat, sausage or cheese and meat-like products, having a hub (9) and a cutting body (10), characterised in that the cutting body (10) comprises at least one cavity (4).

2. A blade according to claim 1, characterised in that it consists of a plurality of parts and/or the cutting body comprises two half-shells (2, 3).

3. A blade according to claim 1, characterised in that the cavity (4) is formed by the first half-shell (2) and the second half-shell (3).

4. A blade according to claim 1, characterised in that the cavity (4) is at least partially filled with a detection fluid.

5. A blade according to claim 1, characterised in that the cavity (4) is at least partially filled with a plastics filling.

6. A blade according to claim 1, characterised in that the cavity (4) comprises a reversibly closable opening (6).

7. A blade according to claim 6, characterised in that the opening (6) is suitable for producing an overpressure or reduced pressure in the cavity (4).

8. A blade according to claim 1, characterised in that the ratio of the hub width (N) to the external diameter of the cutting edge (D) is in the range from 1:3-1:100, preferably in the range from 1:4-1:70 and very particularly preferably in the range from 1:5-1:13.

9. A blade according to claim 1, characterised in that the hub width (N) amounts to 10-300 mm, preferably 15-150 mm.

10. A blade according to claim 2, characterised in that the half-shells are curved and in that the first half-shell (2) exhibits a smaller curvature than the second half-shell (3).

11. A blade according to claim 1, characterised in that the blade is a circular blade, a crescent-shaped blade or a helical blade.

12. A blade according to claim 1, characterised in that the cutting body (10) comprises two half-shells (2, 3) and a cutting edge (1).

13. A blade according to claim 12, characterised in that the cutting edge (1) is inserted between the half-shells (2, 3).

14. A blade according to claim 11, characterised in that the two half-shells (2, 3) exhibit the same diameter.

15. A blade according to claim 11, characterised in that one half-shell (2, 3) exhibits a larger diameter than the other half-shell (2, 3).

16. A blade according to claim 12, characterised in that the cutting edge (1) is made of hardened steel, high speed steel (HSS), hard metal or ceramics.

17. A blade according to claim 2, characterised in that the half-shells (2, 3) are made from steel, stainless steel, aluminium, titanium and high-strength plastics (fibre-reinforced).

18. A blade according to claim 15, characterised in that the edge area of the larger of the two half-shells (2) takes the form of a cutting edge (1).

19. A blade according to claim 18, characterised in that the larger half-shell (2) with cutting edge is made from hardened steel or hard metal and in that the other half-shell (3) is made of stainless steel or aluminium.

20. A blade according to claim 1, characterised in that the components of the blade are connected together interlockingly, by material bonding and/or frictionally (7, 8).

21. A blade according to claim 1, characterised in that the components of the blade are connected together in leakproof manner.

22. A blade according to claim 1, characterised in that it comprises ribs, connecting webs and/or supporting materials between the half-shells (2, 3).

23. A blade according to claim 1, characterised in that it comprises bushes (5) for balancing purposes.

24. A blade according to claim 1, characterised in that a temperature-control medium is arranged in at least one cavity, with which medium the blade may be at least partially temperature-controlled.

25. A slicing machine comprising a blade according to claim 1.

26. A method of producing blades with a cavity (4) in the a cutting body (10), characterised in that the blade comprises a hub (9) and in that the components of the blade (1, 2, 3, 9) are inserted in one another and connected together interlockingly, by material bonding and/or frictionally (7, 8).

27. A method of detecting leakage in blades with a cavity (4) in the cutting body (10), characterised in that the cavity (4) of the blade is at least partially filled with a detection fluid, which escapes from the blade if the cavity (4) has a leak.

28. A method according to claim 27, characterised in that the cavity, in which the detection fluid is located, is placed under overpressure.

29. A method according to claim 27, characterised in that the blade is exposed to a reduced pressure.

30. A method according to claim 27, characterised in that leakage is monitored when the blade is in operation.

31. A method according to claim 27, characterised in that escape of the detection fluid from the blade is detected with the aid of a suitable monitoring device.

32. A method according claim 27, characterised in that the cutting process is terminated if the detection fluid is detected.
